(19) United States
(12) Patent Application Publication
(10) Pub. No.: US 2004/0140155 A1
(43) Pub. Date: Jul. 22, 2004

(54) Ladder safety attachment

(76) Inventors: Ming Cheng Yang, Bellaire, TX (US); Chi Chung Chen, Houston, TX (US)

Correspondence Address: JOSEPH M. JONG, 3231 SOUTHDOWN DRIVE, PEARLAND, TX, 77584, US

(21) Appl. No.: 10/348,559

(22) Filed: Jan. 21, 2003

(51) Int. Cl. E06C 7/42

(52) U.S. Cl. 182/107

(57) ABSTRACT

An apparatus for stabilizing a ladder. In one embodiment, the apparatus comprises a frame releasably attachable to the ladder, and one or more stabilizer arms extending from the frame. The apparatus may include one or more clamps rotatably disposed on the frame for securing the apparatus on the ladder, and the one or more clamps may be disposed in a fixed rotational relationship with the one or more stabilizer arms. The frame may comprise a first and second brace members disposed in mating engagement, and the first and second brace members may be adjustably securable to each other by releasable fasteners.

### BACKGROUND OF THE INVENTION

1. Field of the Invention

The present invention generally relates to ladders, and more particularly, the present invention relates to a ladder safety apparatus which may be adjustably attached to a ladder and provides additional stability.

2. Description of the Related Art

Most extension ladders for reaching heights at least one-story high are typically placed at a slight angle to vertical (e.g., between 5 and 20 degrees) such that a top portion of the ladder rests against an edge of a structure (e.g., an edge of a roof of a building or a top portion of a wall). The surface adjacent the edge of the building may be a generally horizontal surface (e.g., top surface of a wall or a flat roof) or an angled surface (e.g., a slanted roof). The surfaces where the ladder contacts the edge of the building are minimal, and yet, the ladder relies on friction between the ladder and the edge of the building structure to prevent itself from sliding off to either sides. The ladder may easily slide off to either side particularly when the ladder is not placed on firm grounds or when the ladder is positioned incorrectly. Also, the ladder may slide off to either side because a person climbing up or coming down the ladder may lose balance himself or shift the balance of the ladder, resulting in injury to the person falling off the ladder. Furthermore, it is dangerous and inconvenient to use currently available stability attachments to ladders because these attachments require attachment after ladder is placed in position (i.e., a person still has to make the initial climb up the ladder to install and adjust the attachment).

Therefore, a need exists for a ladder safety attachment which provides improved stability of a ladder positioned against a wall or roof. A need also exists for a ladder safety attachment that is easy to install onto a ladder and convenient to use and transport. Furthermore, there is a need for a ladder safety attachment whose position on the ladder can be adjusted without requiring a person to climb up onto the ladder.

### SUMMARY OF THE INVENTION

Embodiments of the invention generally provide an apparatus for stabilizing a ladder, and more particularly, a ladder safety attachment which provides improved stability of a ladder positioned against a wall or roof. The ladder safety attachment is easy to install onto a ladder and convenient to use and transport. The ladder safety attachment provides increased stability as the weight on the ladder increases. Also, the position of the ladder safety attachment on the ladder can be adjusted without requiring a person to climb up onto the ladder.

One embodiment of the invention provides an apparatus for stabilizing a ladder comprising a frame releasably attachable to the ladder, and one or more stabilizer arms extending from the frame. The apparatus may include one or more clamps rotatably disposed on the frame for securing the apparatus on the ladder, and the one or more clamps may be disposed in a fixed rotational relationship with the one or more stabilizer arms. The frame may comprise a first and second brace members disposed in mating engagement, and the first and second brace members may be adjustably securable to each other by releasable fasteners.

Another embodiment provides an apparatus for stabilizing a ladder, comprising a frame releasably attachable to the ladder; one or more stabilizer arms rotatably disposed on and extending from the frame; and one or more clamps rotatably disposed on the frame for securing the apparatus on the ladder, wherein the one or more clamps are disposed in a fixed rotational relationship with the one or more stabilizer arms. Each clamp rotates between a plurality of positions selected from a clamping position, a disengaged position and a holding position. The apparatus may further comprise a spring disposed against each clamp to bias the clamp in the holding position.

Yet another embodiment provides an apparatus for stabilizing a ladder, comprising a frame releasably attachable to the ladder, the frame comprising a first and second brace members disposed in mating engagement, the first and second brace members adjustably securable to each other by releasable fasteners; and one or more stabilizer arms rotatably disposed on and extending from the frame. The first brace member comprises a first front slotted plate and a first rear slotted plate and the second brace member comprises a second front slotted plate and a second rear slotted plate, wherein the first front slotted plate is disposed in mating engagement with the second rear slotted plate and the second front slotted plate is disposed in mating engagement with the first rear slotted plate.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a perspective view of one embodiment of a ladder stabilizer attachment 100.

FIG. 2 is an exploded perspective view of a frame 110 comprising first and second brace members 122, 124.

FIGS. 3 is a perspective view of a ladder stabilizer attachment 100 being installed onto a ladder 190.

FIGS. 4A-C are side views of one embodiment of a ladder stabilizer attachment 100 disposed on a ladder 190.

### DETAILED DESCRIPTION OF THE PREFERRED EMBODIMENT

Embodiments of the invention generally provide an apparatus for stabilizing a ladder, and more particularly, a ladder safety attachment which provides improved stability of a ladder positioned against a wall or roof. The ladder safety attachment is easy to install onto a ladder and convenient to use and transport. The ladder safety attachment provides increased stability as the weight on the ladder increases. Also, the position of the ladder safety attachment on the ladder can be adjusted without requiring a person to climb up onto the ladder.

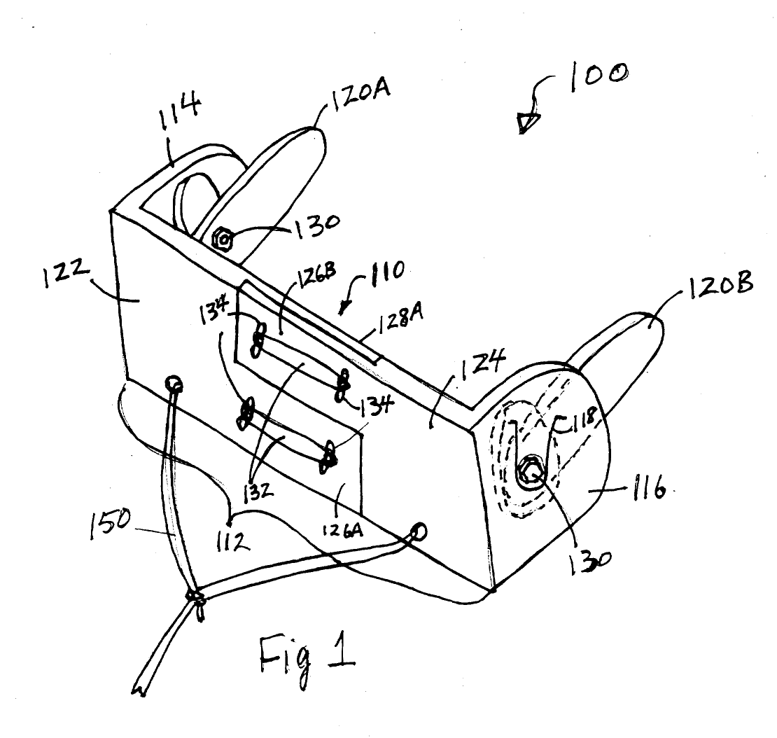

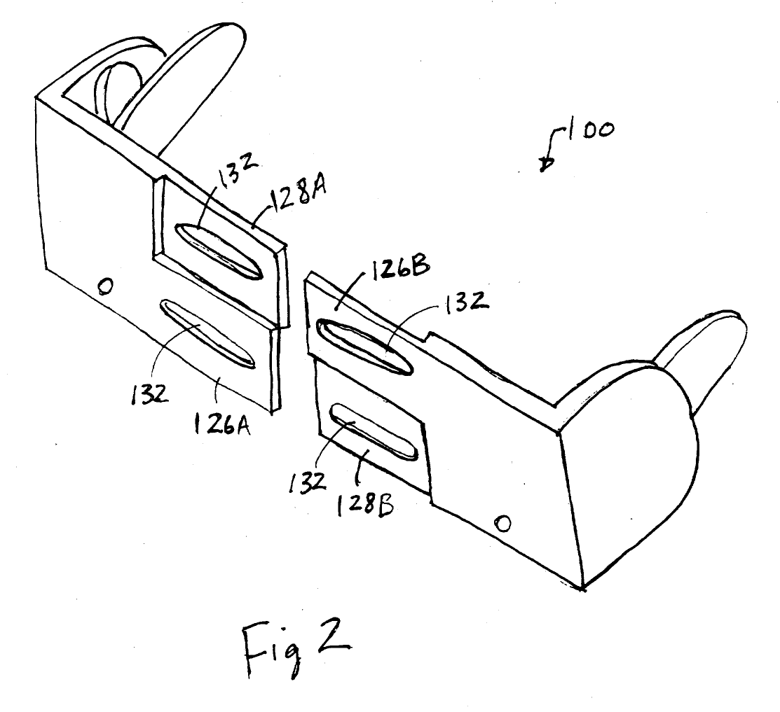

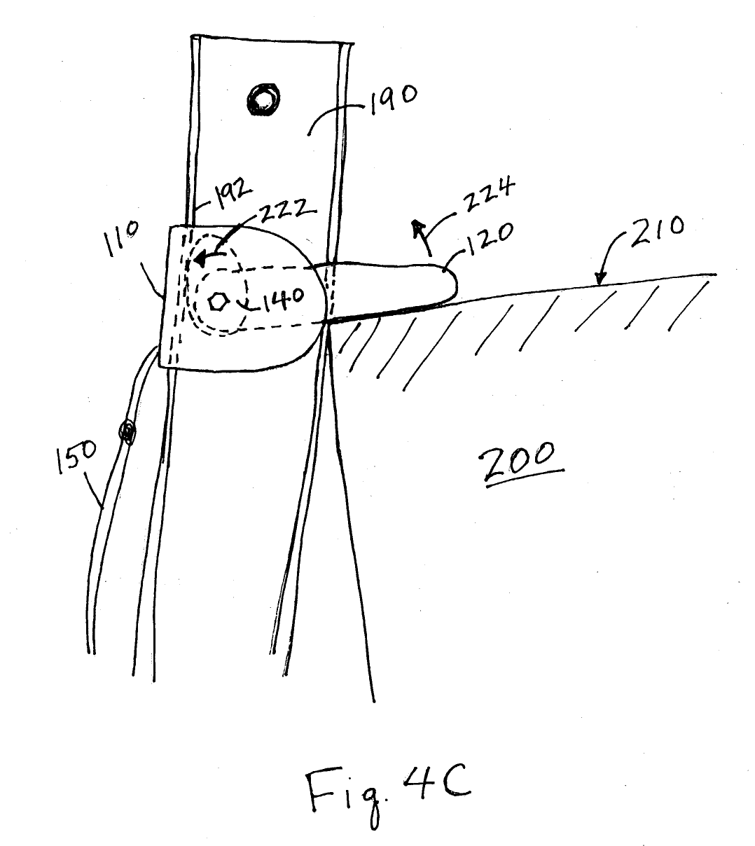

FIG. 1 is a perspective view of one embodiment of a ladder stabilizer attachment 100. The ladder stabilizer attachment 100 generally comprises a frame 110 and one or more stabilizer arms 120 extending from the frame 110. In one embodiment, the frame 110 includes a cross brace 112, a left side brace 114 and a right side brace 116, and the left and right side braces 114, 116 are disposed at the ends of the cross brace 112, forming substantially 90 degree angles. A first stabilizer arm 120A may be attached to the left side brace 114, and a second stabilizer arm 120B may be attached to the right side brace 116. A fastener 130, such as a bolt, a screw, a nut/bolt assembly, etc., may be utilized to pivotally attach the stabilizer arms 120 to the side braces 114, 116. The stabilizer arms 120 may pivot or rotate between a plurality of positions (examples shown in FIGS. 4A-C), with the fastener 130 setting the pivot point or the center of rotation. Clamps 140A and 140B may be pivotally attached to the side braces 114, 116, respectively, with the fasteners 130. In one embodiment, each clamp 140 may be disposed in a fixed rotational relationship with a corresponding stabilizer arm 120 such that the clamp 140 rotates as the stabilizer arm 120 is rotated about the pivot point set by the fastener 130. For example, each clamp 140 may be glued, pegged or screwed to its corresponding stabilizer arm 120. In another embodiment, the clamp 130 and the stabilizer arm 120 may comprise a monolithic structure (e.g., one-piece construction).

Alternatively, each clamp 140 may have a limited rotational movement relative to its corresponding stabilizer arm. For example, a spring 118 may be disposed between a clamp 140 and its corresponding stabilizer arm 120 to bias the positional relationship between the clamp 140 and the stabilizer arm 120, and the clamp 140 may be pushed by the stabilizer arm 120 as the stabilizer arm 120 rotates. The spring may be positioned to bias the clamp with respect to the side brace. In another embodiment, movement of each clamp may be limited in a range to its corresponding stabilizer arm through a peg and a sliding slot/hole disposed on oppositely on the clamp and stabilizer arm.

The clamps 140 may be disposed on the side braces 114, 116 of the frame 110 and utilized for securing the ladder stabilizer attachment 100 on a ladder. The clamps 140 may be oval-shaped and are rotatably or pivotally attached to the frame, and each clamp rotates or pivots between a clamping position, a disengaged position and a holding position. In the clamping position (as shown in FIG. 4C), the clamps 140 secures the ladder stabilizer attachment 100 to the side rails of a ladder through friction and pressure caused by the weight on the ladder (e.g., any person on the ladder) and the weight of the ladder itself acting on the stabilizer arms which translates rotational force to the clamps. The clamps 140 may be pushed or rotated into the clamping position as the stabilizer arms engages a top surface of a wall or roof. In the disengaged position (as shown in FIG. 4B), the ladder stabilizer attachment 100 may be moved freely along the side rails of the ladder. The disengaged position may include a range of rotation of the clamp 140 between the clamping position and the holding position. In the holding position (as shown in FIG. 4A), the clamps 140 provides sufficient friction against the side rails of the ladder such that the ladder stabilizer attachment 100 remains on the ladder while the ladder is moved and placed into position against a wall or a roof. The clamps 140 may be rotated into the holding position due the weight of the stabilizer arms, particularly when the ladder (with the ladder stabilizer attachment 100 attached) is vertically oriented, such as when the ladder is being moved into a position against a wall or roof.

A spring 118 may be disposed against each clamp and biased to keep the clamp in the holding position. In one embodiment, one end of a spring 118 is fixedly attached to the side brace (114 or 116) of the frame 110 while the other end is attached to the clamp 140. With the clamps 140 biased in the holding position, the ladder stabilizer attachment 100 may be installed or attached to a ladder at a particular position and remain in that position unless a sufficient force is applied to the frame 110 of the ladder stabilizer attachment 100 in the upward or downward directions with respect to the ladder. For example, a pull rope (position adjuster 150) may be attached to the frame of the ladder stabilizer attachment 100 to adjust the position of the ladder stabilizer attachment 100 with respect to the ladder. Preferably, the ladder stabilizer attachment 100 is initially attached to the ladder at a higher position than the actual working position, and after the ladder is positioned correctly against a wall or roof, the position of the ladder stabilizer attachment 100 may be adjusted downwardly (e.g., by pulling on the pull rope) until the stabilizer arms 120 push the clamps 140 securely into the clamping position. Alternatively, the spring 118 may be disposed against each clamp and biased to keep the clamp in the disengaged position. With the clamps 140 biased in the disengaged position, the ladder stabilizer attachment 100 may be attached to a ladder but remain freely adjustable up and down the ladder.

In one embodiment, the frame 110 comprises a first brace member 122 (e.g., representing the left side brace and the left portion of the cross brace) and a second brace member 124 (e.g., representing the right side brace and the right portion of the cross brace). The first and second brace members 122, 124 may be adjustably securable to each other. The first and second brace members 122, 124 may be identical to each other, and it is contemplated that the first and second brace members may be made from the same mold. FIG. 2 is an exploded perspective view of a frame 110 comprising first and second brace members 122, 124. In one embodiment, the first brace member 122 includes a left portion of the cross brace 112 and the left side brace 114, and the second brace member includes a right portion of the cross brace 112 and the right side brace 116. Each brace member includes a sliding joint, which comprises a front plate 126 and a rear plate 128. The front plate 126A of the left brace member 122 is disposed in mating engagement with the rear plate 128B of the right brace member 124, and the front plate 126B of the right brace member 124 is disposed in mating engagement with the rear plate 128A of the left brace member 122. In one embodiment, the front plate 126A of the left brace member 122 extends through a bottom portion while the rear plate 128A extends through a top portion, and each of the front plate 126A and rear plate 128A has about half the thickness of the frame 110. Correspondingly, the front plate 126B of the right brace member 124 extends through a top portion while the rear plate 128B extends through a bottom portion, and each of the front plate 126B and rear plate 128B has about half the thickness of the cross brace 112 of the frame 110.

Each front plate 126 and each rear plate 128 may include a slot 132 or a plurality of holes through which one or more fasteners 134 may be inserted. Each front plate 126 may be secured with its mating rear plate 128 utilizing one or more fasteners 134. An example of a fastener 134 is a butterfly nut and bolt assembly which can be easily turned by hand to fasten and unfasten. In one embodiment, as illustrated in FIG. 1, two sets of butterfly nut and bolt assemblies are disposed through the slots to secure corresponding front and rear plates. The mating engagement of the first brace member 122 and the second brace member 124 provides strength to the frame 110 and restricts twisting of the frame 110 when the corresponding front plates 126 and rear plates 128 are fastened together while allowing the width of the frame 110 to be adjusted to fit various ladders and to facilitate installation of the ladder stabilizer attachment 100.

The width of the frame 110 may be adjusted by adjusting the positioning of the front plates 126 relatively to the rear plates 128. Thus, the ladder stabilizer attachment 100 may be utilized for various ladders having different widths. In one embodiment, the positions of the front plates 126 relatively to the rear plates 128 may be adjusted by unfastening the butterfly nuts 134A (e.g., just enough for moving the plates) and moving the plates (either pull apart or push together) until the relative positioning of the front plates 126 and the rear plates 128 provides the desired width of the frame 110. The butterfly nuts 134A are then fastened to secure the plates together.

The ladder stabilizer attachment 100 may also include a position adjuster 150 which is attachable to the frame to adjust the position of the ladder stabilizer attachment 100 on the ladder. In one embodiment, the position adjuster 150 may be a pull rope that is attached to the frame of the ladder stabilizer attachment 100. The pull rope may be inserted through one or more holes 152 on the frame 110 and tied to itself. In one embodiment, the pull rope is inserted through two holes 152 on the frame 110 and is tied to itself, and when pulled at the other end, the pull rope becomes Y-shaped and distributes the pulling force substantially equally to the left and right sides of the frame 110 of the ladder stabilizer attachment 100. In another embodiment, the position adjuster may be a pole that is releasably attachable to the frame and may be utilized to move the ladder stabilizer attachment 100 up and/or down the ladder.

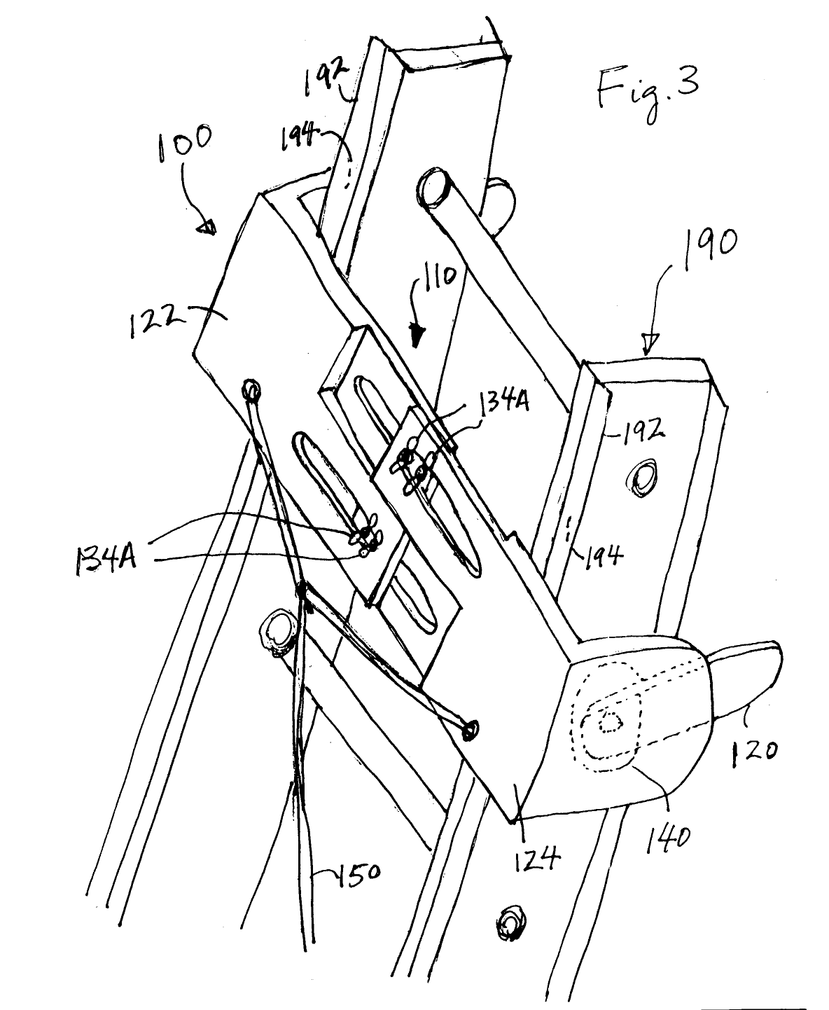

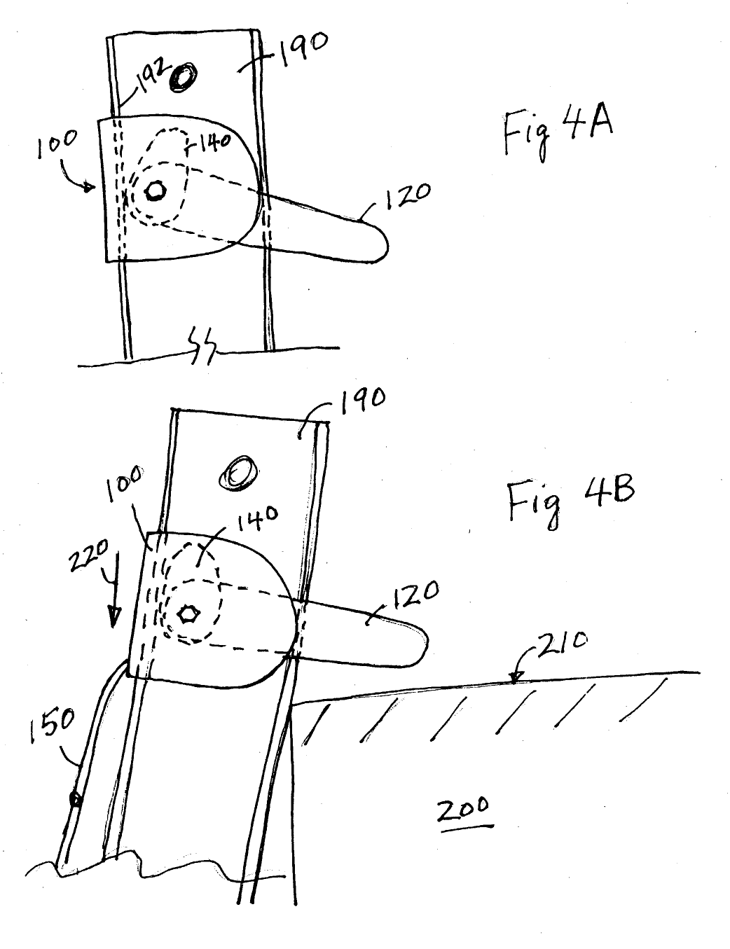

FIGS. 3 is a perspective view of a ladder stabilizer attachment 100 being installed onto a ladder 190. FIGS. 4A-C are side views of one embodiment of a ladder stabilizer attachment 100 disposed on a ladder 190. An installation of one embodiment of the ladder stabilizer attachment 100 onto a ladder is illustrated through FIG. 3 and FIGS. 4A-C. To install a ladder stabilizer attachment 100, the butterfly nuts 134A are first loosened to allow the left brace member 122 to move relative to the right brace member 124 such that the frame 110 is extended to provide sufficient clearance between the clamps 140 and the side rails 192 of the ladder 192. The frame 110 is then positioned horizontally at a desired location on the ladder, as shown in FIG. 3A. In one embodiment, the ladder stabilizer attachment 100 is positioned at a position higher than the estimated contact point between the ladder 190 and a roof, and the ladder stabilizer attachment 100 is adjusted downwardly toward the contact point after the ladder is propped against the wall or roof. The left brace member 122 and the right brace member 124 are then pushed together to position the clamps 140 against an interior surface 194 of the side rails 192 of the ladder 190, and the butterfly nuts 134A are fastened to secure the left brace member 122 and the right brace member 124. When the ladder 190 is moved toward or into a vertically oriented position, as shown in FIG. 4A, the weight of the stabilizer arms 120 rotates the clamps 130 to a holding position in which the ladder 190 may be moved and propped against a wall or a roof 200 while the ladder stabilizer attachment 100 remains in position on the ladder 190.

Once the ladder 190 has been positioned against the wall or roof 200, the position adjuster 150 is utilized to move the ladder stabilizer attachment 100 such that the stabilizer arms 120 engage the top surface 210 of the wall or roof 200. In one embodiment, as shown in FIG. 4B, the ladder stabilizer attachment 100 is moved downwardly the ladder 190 (shown by arrow 220) to engage the top surface 210 of the wall or roof 200, and as the ladder stabilizer attachment 100 is moved by the position adjuster 150, the clamps 140 are briefly forced into the disengaged position to allow movement of the ladder stabilizer attachment 100. A shown in FIG. 4C, the ladder stabilizer attachment 100 has been moved to the engagement position where the stabilizer arms 120 engage the top surface 210 of the wall or roof 200. The clamps 140 are pushed (arrow 222) into the clamping position by rotation (arrow 224) of the stabilizer arms 120 due to the weight of the ladder and the weight of any person or things on the ladder. Any increase in weight on the ladder increases the force applied to the clamps 140 such that the clamps 140 become more tightly clamped against the rail 192 of the ladder 190, and correspondingly, the frictional force between the stabilizer arms 120 and the top surface 210 of the wall or roof 200 are increased to provide improved protection against sideways slippage of the ladder 190.

While the foregoing is directed to embodiments of the present invention, other and further embodiments of the invention may be devised without departing from the basic scope thereof, and the scope thereof is determined by the claims that follow.

1. An apparatus for stabilizing a ladder, comprising:
a frame releasably attachable to the ladder; and
one or more stabilizer arms extending from the frame.

2. The apparatus of claim 1, further comprising:
one or more clamps disposed on the frame for securing the apparatus on the ladder.

3. The apparatus of claim 2, wherein each clamp comprises an oval shaped disc rotatably disposed on the frame.

4. The apparatus of claim 2, wherein the one or more clamps are rotatably attached to the frame, wherein each clamp rotates between a plurality of positions selected from a clamping position, a disengaged position and a holding position.

5. The apparatus of claim 2, further comprising a spring disposed against each clamp to bias the clamp in the holding position.

6. The apparatus of claim 2, wherein the one or more clamps are disposed in a fixed rotational relationship with the one or more stabilizer arms.

7. The apparatus of claim 2, wherein a monolithic structure forms one clamp and one stabilizer arm.

8. The apparatus of claim 1, wherein the frame comprises a first and second brace members disposed in mating engagement, the first and second brace members adjustably securable to each other by releasable fasteners.

9. The apparatus of claim 8, wherein the first brace member comprises a first front slotted plate and a first rear slotted plate and the second brace member comprises a second front slotted plate and a second rear slotted plate, wherein the first front slotted plate is disposed in mating engagement with the second rear slotted plate and the second front slotted plate is disposed in mating engagement with the first rear slotted plate.

10. The apparatus of claim 1, further comprising a position adjuster removably attachable to the frame.

11. An apparatus for stabilizing a ladder, comprising:
a frame releasably attachable to the ladder; and
one or more stabilizer arms rotatably disposed on and extending from the frame; and
one or more clamps rotatably disposed on the frame for securing the apparatus on the ladder, wherein the one or more clamps are disposed in a fixed rotational relationship with the one or more stabilizer arms.

12. The apparatus of claim 11, wherein each clamp rotates between a plurality of positions selected from a clamping position, a disengaged position and a holding position.

13. The apparatus of claim 12, further comprising a spring disposed against each clamp to bias the clamp in the holding position.

14. The apparatus of claim 11, wherein the frame comprises a first and second brace members disposed in mating engagement, the first and second brace members adjustably securable to each other by releasable fasteners.

15. The apparatus of claim 11, wherein the first brace member comprises a first front slotted plate and a first rear slotted plate and the second brace member comprises a second front slotted plate and a second rear slotted plate, wherein the first front slotted plate is disposed in mating engagement with the second rear slotted plate and the second front slotted plate is disposed in mating engagement with the first rear slotted plate.

16. An apparatus for stabilizing a ladder, comprising:
a frame releasably attachable to the ladder, the frame comprising a first and second brace members disposed in mating engagement, the first and second brace members adjustably securable to each other by releasable fasteners; and
one or more stabilizer arms rotatably disposed on and extending from the frame.

17. The apparatus of claim 16, wherein the first brace member comprises a first front slotted plate and a first rear slotted plate and the second brace member comprises a second front slotted plate and a second rear slotted plate, wherein the first front slotted plate is disposed in mating engagement with the second rear slotted plate and the second front slotted plate is disposed in mating engagement with the first rear slotted plate.

18. The apparatus of claim 16, further comprising one or more clamps rotatably disposed on the frame for securing the apparatus on the ladder, wherein the one or more clamps are disposed in a fixed rotational relationship with the one or more stabilizer arms.

19. The apparatus of claim 18, wherein each clamp rotates between a plurality of positions selected from a clamping position, a disengaged position and a holding position.

20. The apparatus of claim 19, further comprising a spring disposed against each clamp to bias the clamp in the holding position.
